(19) United States
(12) Patent Application Publication
(10) Pub. No.: US 2010/0247397 A1
(43) Pub. Date: Sep. 30, 2010

(54) MAGNETIC COUPLING DEVICE FOR AN ELEVATOR SYSTEM

(76) Inventors: Jacek F. Gieras, Glastonbury, CT (US); Pei-Yuan Peng, Ellington, CT (US); Bryan Siewert, Westbrook, CT (US)

Correspondence Address: CARLSON GASKEY & OLDS, 400 W MAPLE STE 350, BIRMINGHAM, MI, 48009, US

(21) Appl. No.: 12/524,258

(22) PCT Filed: Mar. 22, 2007
(86) PCT No.: PCT/US07/64673

§ 371 Date: Jul. 23, 2009

(30) Foreign Application Priority Data
Mar. 30, 2006 (JP) 2006-094932

(51) Int. Cl. B01D 53/94; B01J 21/04

(52) U.S. Cl. 422/177; 502/439

(57) ABSTRACT

A catalyst-carrier supporting material of a catalytic converter excellent in heat resistance and capable of maintaining a sufficient holding capability for supporting the catalyst-carrier for a long duration even in the environments exceeding 950° C. The catalyst-carrier supporting material comprising: a heat resistant layer which contains crystalline alumina fibers and an organic binder evenly impregnated with the crystalline alumina fibers and to be eliminated by thermal decomposition; and a thermally intumescent layer layered on the heat resistant layer which contains crystalline alumina fibers, an organic binder dispersed in the crystalline alumina fibers and to be eliminated by thermal decomposition, and vermiculite dispersed in the crystalline alumina fibers, wherein the crystalline alumina fibers exist in an amount of 1,400 g/m2 or higher in the catalyst-carrier supporting material, the ratio of the amount of the crystalline alumina fibers existing in the heat resistant layer and the amount of the crystalline alumina fibers existing in the thermally intumescent layer is 0.98 to 1.98, and the vermiculite exists in an amount of 23 to 33% by weight in the thermally intumescent layer.

The present invention relates to a catalytic converter to be used mainly for automobiles and particularly inorganic fiber formed body to be used as a catalyst-carrier supporting material for the converter.

### BACKGROUND

A catalytic converter is an apparatus for removing harmful components such as carbon monoxide, hydrocarbons, and nitrogen oxides contained in an exhaust gas of an internal combustion engine by a noble metal catalyst.

Since decomposition efficiency of harmful substances is heightened in the case where a catalyst and an exhaust gas are heated to a high temperature, a catalytic converter has been installed as near as possible to an engine in recent years. Also, recently, the temperature of an exhaust gas has been increased to high so as to improve the fuel performance of an engine and it sometimes exceeds 950° C. Therefore, component parts of the catalytic converter are required to have sufficient heat resistance to be used in environments of 950° C.

Japanese Patent Laid-open Publication No. H10 (1998)-288032 describes a structure of the catalytic converter. The catalytic converter comprises a cylindrical carrier for an exhaust gas purification catalyst, a casing made of a metal for housing the carrier and connected to an exhaust gas introduction pipe, and a catalyst-carrier supporting material rolled around the carrier and filling the gap between the carrier and the casing.

This catalyst-carrier supporting material comprises a heat resistant layer containing alumina fibers and an organic binder dispersed in the alumina fibers and to be eliminated by thermal decomposition and a thermally intumescent layer layered on the heat resistant layer which contains ceramic fibers and an organic binder dispersed in the ceramic fibers and to be eliminated by the thermal decomposition, and an inorganic intumescent material dispersed in the ceramic fibers. It aims to prevent high temperature thermal deterioration of the thermally intumescent layer by the layer of alumina fibers. Herein, fibers with a mullite composition having an alumina content lower than 90% are also explained as alumina fibers and in this point, the fibers are different from the crystalline alumina fibers of the present invention.

However, the catalyst-carrier supporting material is insufficient in the heat resistance in terms of the above-mentioned requirements in recent years. For example, if the exhaust gas temperature exceeds 950° C., the catalyst-carrier supporting capability of the catalyst-carrier supporting material is deteriorated with in a short time around 50 hours.

A cause of the insufficiency of the heat resistance is supposed to due to vermiculite used generally as a thermally intumescent material for such kind of a catalyst-carrier supporting material. For example, Japanese Patent Laid-open Publication No. H7(1995)-77036 has a description in the 0004th paragraph that a thermally intumescent layer containing alumina fibers and vermiculite added thereto is deteriorated in the generated in-plane pressure property at a temperature of 800 to 900° C. as an upper limit. Also, Japanese Patent Laid-open Publication No. H8 (1996)-338237 has a description in the 0012th paragraph that a thermally intumescent material containing ceramic fibers and vermiculite added thereto is extremely deteriorated if it is exposed to an exhaust gas at a temperature exceeding 850° C.

Japanese Patent Laid-open Publication No. H7(1995)-197811 also has a description of a structure of a catalytic converter and it says that a catalyst-carrier supporting material obtained by forming a mixture containing vermiculite and ceramic fibers into a sheet-like shape is inferior in the heat resistance. There is an explanation that the cause of the inferior heat resistance is due to decomposition of the vermiculite at a temperature exceeding 850° C. (paragraph 0004).

Further, Japanese Patent Laid-open Publication No. H7(1995)-197811 has a description of a compacting crystalline alumina fiber layer formed by needle-punching together with organic fibers as a catalyst-carrier supporting material for a catalytic converter excellent in the heat resistance. The catalyst-carrier supporting material is characterized in that no vermiculite inferior in heat resistance is used in this material.

However, the conventional catalyst-carrier supporting materials are all still insufficient in the heat resistance and incapable of maintaining a proper catalyst-carrier supporting capability for a long period in environments at lowest 950° C. or higher.

### SUMMARY

The present invention is for solving the above-mentioned conventional problems and aims to provide a catalyst-carrier supporting material of a catalytic converter excellent in heat resistance and capable of keeping a sufficient holding capability for supporting a catalyst-carrier for a long duration even in an environment exceeding 950° C.

The present invention provides a catalyst-carrier supporting material comprising:

a heat resistant layer which contains crystalline alumina fibers and an organic binder evenly impregnated with the crystalline alumina fibers and to be eliminated by thermal decomposition; and

a thermally intumescent layer layered on the heat resistant layer which contains crystalline alumina fibers, an organic binder dispersed in the crystalline alumina fibers and to be eliminated by thermal decomposition, and vermiculite dispersed in the crystalline alumina fibers, wherein

the crystalline alumina fibers exist in an amount of 1,400 g/m² or higher in the catalyst-carrier supporting material,

the ratio of the amount of the crystalline alumina fibers existing in the heat resistant layer and the amount of the crystalline alumina fibers existing in the thermally intumescent layer is 0.98 to 1.98, and

the vermiculite exists in an amount of 23 to 33% by weight in the thermally intumescent layer, and accordingly, the above-mentioned aims have been accomplished.

The catalyst-carrier supporting material of a catalytic converter of the present invention is excellent in heat resistance and capable of keeping a sufficient holding capability for supporting a catalyst-carrier even in environments at a temperature exceeding 950° C.

### BRIEF DESCRIPTION OF THE DRAWINGS

FIG. 1 is a perspective view showing a portion of a catalyst-carrier supporting material of the present invention.

FIG. 2 is a perspective view showing a typical catalytic converter according to the present invention.

### DETAILED DESCRIPTION

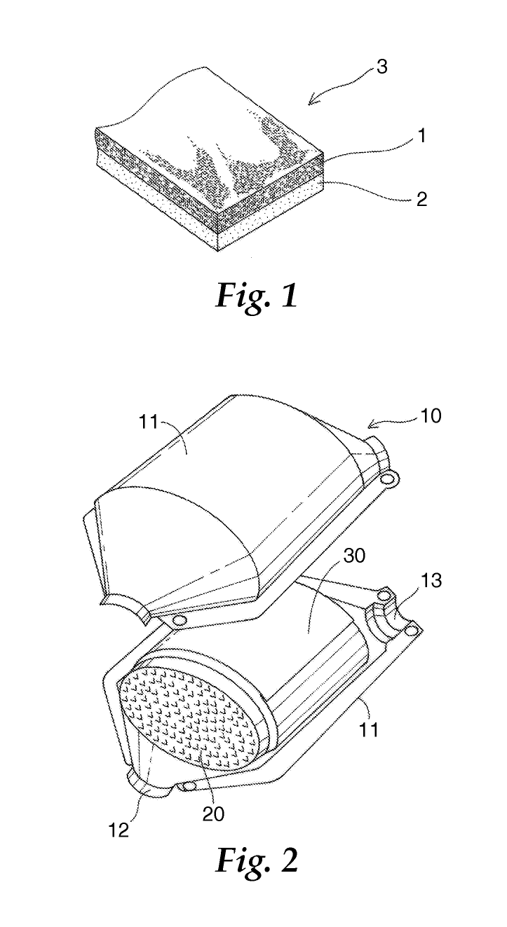

FIG. 1 is a perspective view showing a part of a catalyst-carrier supporting material of the present invention. The catalyst-carrier supporting material 3 comprises a heat resistant layer 1 and a thermally intumescent layer 2 layered on thereon.

The heat resistant layer 1 is an assembly of crystalline alumina fibers integrated approximately evenly in the thickness direction and includes so-called blanket or block. In general, those having a fiber diameter of 1 to 50 μm and a fiber length of 0.5 to 500 mm are used as the crystalline alumina fibers and in terms of compaction restoration power and the shape holding property, fibers with a fiber diameter of 3 to 8 μm and a fiber length of 0.5 to 300 mm are particularly preferable.

The above-mentioned crystalline alumina fibers have a composition with an alumina content of 90% by weight or higher and a silica content less than 10% by weight. Preferably, the alumina content is 94% by weight or higher.

Crystalline alumina fibers are excellent in heat resistance as compared with non-crystalline ceramic fibers and scarcely thermally deteriorated by shrinkage along with proceeding of crystallization just like ceramic fibers and further provided with elasticity in the case of being subjected to prescribed compaction. That is. the crystalline alumina fiber layer has a high holding capability with a low bulk density and keeps the characteristics with little fluctuation even at a high temperature. Accordingly, in the case of using them as a catalyst-carrier supporting material for a catalytic converter, even if the gap between the carrier and the casing is changed because of thermal expansion and the bulk density is fluctuated, the holding pressure alteration to the carrier can be suppressed to low.

Any organic binder may be used without any particular limit if it can maintain the thickness of a compacted layer at a normal temperature and recover the thickness of the layer after it is eliminated by thermal decomposition and it is needed to avoid use of an organic binder which is not decomposed even at a use temperature of the carrier or higher or which adversely interferes the flexibility or the recovered in-plane pressure property of the layer and promotes breakage of the carrier in the case where the fibers are impregnated with the organic binder. Various kinds of rubbers, water-soluble organic polymer compounds, thermoplastic resins, and thermosetting resins can be used as the organic binder.

Examples of the above-mentioned rubbers may include natural rubbers, acrylic rubbers such as copolymers of ethyl acrylate and chloroethyl vinyl ether, copolymers of n-butyl acrylate and acrylonitrile, and copolymers of ethyl acrylate and acrylonitrile; nitrile rubbers such as copolymers of butadiene and acrylonitrile; and butadiene rubbers. Examples of the water-soluble organic polymer compounds may include carboxymethyl cellulose and polyvinyl alcohol. Examples of the thermoplastic resins may include acrylic resins of homopolymers and copolymers of acrylic acid, acrylic acid esters, acrylamide, acrylonitrile, methacrylic acid, and methacrylic acid ester; acrylonitrile-styrene copolymers; and acrylonitrile-butadiene-styrene copolymers. Also, examples of the thermosetting resins are bisphenol type epoxy resins and novolak type epoxy resins.

Aqueous solutions, water dispersion type emulsions, latexes, organic solvent solutions containing the above-mentioned organic binders as effective components (hereinafter they are collectively referred to as binder solutions) have been commercialized and these binder solutions can be used while being diluted with a solvent such as water and they are thus relatively economically available. In this connection, the organic binder is not necessarily needed to be a single type but two or more kinds of organic binders may be used in form of a mixture.

The content of the organic binder is not particularly limited and may be determined in accordance with the type and shape of the crystalline alumina fibers, the absolute thickness of the layer, and the thickness and resilient force as a formed body containing the organic fibers before the formed body is assembled in a casing made of a metal of the catalytic converter. The content of the organic binder is adjusted to be generally 3 to 30 parts by weight on the basis of the effective component to 100 parts by weight of the crystalline alumina fibers. In the case where the content of the organic binder is less than 3 parts by weight, it may become impossible to keep the thickness as a formed body because of the resilience of the substrate layer and if it exceeds 30 parts by weight, the holding capability deterioration due to weight loss of the organic binder by burning may be increased and further the flexibility as a formed body may possibly be deteriorated. From such a viewpoint, an applicable ratio of the organic binder is generally in a range of 5 to 20 parts by weight.

The heat resistant layer 1 can be formed by a paper manufacturing method. The layer is produced by steps of producing a slurry by adding an organic binder to crystalline alumina fibers dispersed in water; dewatering the slurry on a mesh by a paper manufacturing method; compacting the layer formed on the mesh in the thickness direction; and removing water and the solvent portion of the organic binder by drying.

The heat resistant layer 1 may be formed by using a crystalline alumina fiber blanket subjected to needle punching treatment. In that case, the layer may be formed by steps of impregnating the blanked subjected to needle punching treatment with the organic binder; compacting the layer impregnated with the organic binder solution in the thickness direction; and drying the solvent portion of the organic binder solution by drying. If necessary, the organic binder may be used while being diluted with water.

The thermally intumescent layer 2 is produced by the same manner as that of the heat resistant layer 1 formed by the paper manufacturing method, except that the vermiculite particles are dispersed in a slurry containing crystalline alumina fibers. If necessary, as inorganic filler, for example, sepiolite-type minerals may be added.

The holding material formed in the above-mentioned manner is preferable to have the following various properties. That is, it is preferable that in the compacted state in which the thickness is equivalent to the gap of the outer circumferential face of a carrier and the inner face of a casing, the material has a restoration power of 0.1 to 8.0 kgf/cm². Such a restoration power is about 0.5 to 8.0 kgf/cm² in the case where the carrier is of a ceramic and about 0.1 to 4.0 kgf/cm² in the case where the carrier is of a metal.

The above-mentioned restoration power is maintained even after the organic binder dispersed in the layer is eliminated by thermal decomposition. The restoration power of the layer is equivalent to the power (compacting power) needed to compact the layer to the thickness equal to the gap of the outer circumferential face of a carrier and the inner face of a casing. Accordingly, in this invention, the compacting force at the time of layer formation is employed as an index of the above-mentioned restoration power.

Vermiculite exists at a ratio of 23 to 33% by weight, preferably 25 to 32% by weight, in the thermally intumescent layer to be obtained. If the ratio of the vermiculite is less than 23% by weight, the pressure to be generated by expansion of the vermiculite at a high temperature is insufficient to give a sufficient catalyst-carrier supporting capability. If it exceeds 33% by weight, when the layer is exposed to a high temperature for a long time, the effect of vermiculite deterioration becomes more significant rather than the pressure obtained by the expansion of the vermiculite and therefore, not only it becomes impossible to obtain a sufficient catalyst-carrier supporting capability but also the pressure generated by vermiculite at the first time of exposure to a high temperature becomes so excess that the pressure which the holding material generates accordingly surpasses the in-plane pressure at the time of canning and it may possibly result in damages on the catalyst-carrier by the pressure.

The thickness of the catalyst-carrier supporting material to be obtained is in a range of 7 to 25 mm, preferably in a range of 10 to 20 mm. If the thickness is thinner than 7 mm, it requires to carry out compaction for controlling the thickness at the time of production to an excess extent and consequently, the crystalline alumina fibers composing the holding material may be folded and broken. As a result, the holding material may possibly cause a trouble that the holding material is scattered or dropped due to the pressure of an exhaust gas of an automobile. If the thickness exceeds 25 mm, the tensile force generated due to the difference of the inner and outer circumferences at the time of rolling the holding material around the catalyst-carrier in the canning step becomes significant and possibly causes a problem of crack formation in the outer circumference layer, that is, the thermally intumescent layer.

The crystalline alumina fibers exist at a ratio of 1400 g/m² or more, preferably 1500 to 2500 g/m², in the catalyst-carrier supporting material to be obtained. If the ratio of the crystalline alumina fibers is lower than 1400 g/m², the thickness of the heat resistant layer for preventing deterioration of the vermiculite contained in the thermally intumescent layer by heat may possibly become insufficient to result in insufficiency of the heat resistance as the holding material.

Further, the ratio of the amount of the crystalline alumina fibers existing in the heat resistant layer and the amount of the crystalline alumina fibers existing in the thermally intumescent layer is 0.98 to 1.98, preferably 1.2 to 1.9. If the ratio is less than 0.98, the heat resistant layer cannot sufficiently shut the heat generated by the catalyst-carrier, so that deterioration of the vermiculite by heat might be promoted and sufficient holding capability might not be obtained.

If the ratio exceeds 1.98, the amount of vermiculite in the entire body of the holding material becomes insufficient and sufficient holding capability cannot be obtained.

FIG. 2 is a perspective view showing a typical structure of a catalytic converter of the present invention. To make the structure easily understandable, the expanded state of the catalytic converter is shown. The illustrated catalytic converter 10 comprises a metal casing 11, a monolith solid catalyst-carrier 20 installed in the metal casing 11, and a catalyst-carrier supporting material 30 installed between the metal casing 11 and the catalyst-carrier 20.

According to the present invention, the catalyst-carrier supporting material 30 comprises a heat resistant layer and a thermally intumescent layer. The material is so installed that the heat resistant layer faces to the catalyst-carrier side. Further, an exhaust gas flow inlet 12 and an exhaust gas flow outlet 13 both having a truncated conical shape are attached to the catalytic converter 10.

In the above-mentioned manner, a catalytic converter usable in environments at a temperature of 950° C. or lower can be provided.

The present invention will be more specifically described by the following examples. However it is not intended that the invention be limited to the illustrated examples.

### EXAMPLES

### Examples 1 to 10 and Comparative Examples 1 to 3

Crystalline alumina fibers (LA, alumina content 96% by weight, manufactured by Saffil Ltd.) and water were added in respective proper amounts to adjust the solid matter concentration to be 0.5% to a Waring blender and stirred for about 10 seconds. The mixture was transferred to a 12 L beaker and acrylic latex with a solid matter concentration of 45.5% (Rhoplex HA-8, manufactured by Rohm & Haas Co.) in an amount of 0.06% to water was added and mixed by a propeller mixer. A sufficient amount of an aqueous solution of 50% aluminum sulfate was added to adjust pH at 4 to 6. A 0.1% flocculant (7530, manufactured by Nalco Co.) solution 10 g was added and mixed by a propeller mixer to obtain a first slurry to be a heat resistant layer.

Similarly, crystalline alumina fibers (LA, manufactured by Saffil Ltd.) and water were added in respective proper amounts to adjust the solid matter concentration to be 0.5% to a Waring blender and stirred for about 10 seconds. The mixture was transferred to a 12 L beaker and acrylic latex with a solid matter concentration of 45.5% (Rhoplex HA-8, manufactured by Rohm & Haas Co.) in an amount of 0.06% to water was added and further non-intumescent vermiculite having a mesh size in a range of 18 to 50 meshes (manufactured by Cometals Inc.) was added and mixed by a propeller mixer. A sufficient amount of an aqueous solution of 50% aluminum sulfate was added to adjust pH at 4 to 6. A 0.1% flocculant (7530, manufactured by Nalco Co.) solution 10 g was added and mixed by a propeller mixer to obtain a second slurry to be a thermally intumescent layer.

After the first slurry was formed by a paper-manufacturing method, the second slurry was successively poured and dewatered to form a formed body with a two-layer structure. The formed body was compacted and densified to a high density by a pair of pressurizing rollers and dried by heating rolls to obtain a catalyst-carrier supporting material containing about 12% of a binder. The amount of the fibers and the amount of the vermiculite to be added to the second slurry were adjusted to obtain the respective catalyst-carrier supporting materials of Examples 1 to 10 and Comparative Examples 1 to 3 as shown in Table 1.

### Comparative Example 4

Crystalline alumina fibers (LA, manufactured by Saffil Ltd.) and water were added in respective proper amounts to adjust the solid matter concentration to be 0.5% to a Waring blender and stirred for about 10 seconds. The mixture was transferred to a 12 L beaker and acrylic latex with a solid matter concentration of 45.5% (Rhoplex HA-8, manufactured by Rohm & Haas Co.) in an amount of 0.06% to water was added and mixed by a propeller mixer. A sufficient amount of an aqueous solution of 50% aluminum sulfate was added to adjust pH at 4 to 6. A 0.1% flocculant (7530, manufactured by Nalco Co.) solution 10 g was added and mixed by a propeller mixer to obtain a first slurry to be a heat resistant layer.

Similarly, ceramic fibers (Kaowool™ HA Bulk, alumina content 55% by weight, manufactured by Thermal Ceramics Co., Ltd.) and water were added in respective proper amounts to adjust the solid matter concentration to be 0.5% to a Waring blender and stirred for about 20 seconds. The mixture was transferred to a 12 L beaker and acrylic latex with a solid matter concentration of 45.5% (Rhoplex HA-8, manufactured by Rohm & Haas Co.) in an amount of 0.06% to water was added and further non-intumescent vermiculite having a mesh size in a range of 18 to 50 meshes (manufactured by Cometals Inc.) was added and mixed by a propeller mixer. A sufficient amount of an aqueous solution of 50% aluminum sulfate was added to adjust pH at 4 to 6. A 0.1% flocculant (7530, manufactured by Nalco Co.) solution 10 g was added and mixed by a propeller mixer to obtain a second slurry to be a thermally intumescent layer.

After the first slurry was formed by a paper-manufacturing method, the second slurry was successively poured and dewatered to form a formed body with a two-layer structure. The formed body was compacted and densified to a high density by a pair of pressurizing rollers and dried by heating rolls to obtain a catalyst-carrier supporting material containing about 12% of a binder.

Test of High Temperature Durable in-Plane Pressure

The test of high temperature durable in-plane pressure is a test for measuring the pressure generated in each catalyst-carrier supporting material under expected use conditions by producing standard conditions actually found in a catalytic converter having a catalyst-carrier. Shintech 1/D manufactured by MTS Systems Corp. is equipped with a pair of sample stands capable of variably changing the gap between the sample stands for sandwiching a catalyst-carrier supporting material sample with a diameter of 45 mm.

A load cell for measuring the pressure generated in the holding material sandwiched in the gap between the sample stands is installed thereon. The pair of the sample stands for holding each sample are enabled to heat separately to different temperatures.

Along with the increase of the temperature, in a catalytic converter, the gap where a catalyst-carrier supporting material existed is widened because of the difference of the thermal expansion coefficients between the metal case and the catalyst-carrier. To reproduce this phenomenon, the gap between the sample stands is continuously increased along with the temperature rise so as to adjust the gap as expected along with the temperature in this measurement.

In the measurement of these examples, the temperature of the sample stand in the heat resistant layer side was increased from a room temperature (about 25° C.) to a high temperature 920° C. and the temperature of the sample stand in the thermally intumescent layer side was increased from a room temperature (about 26° C.) to a high temperature 680° C. and the gap alteration degree increased along with the temperature increase from the room temperature to the high temperature was adjusted to be 0.5 mm. It took about 40 minutes to increase the temperature from the room temperature to the high temperature and after the high temperature was kept for 16 minutes, it was cooled to the room temperature in about 60 minutes and a cycle of these steps was repeated 500 times.

The in-plane pressure on completion of the retention at the high temperature of the 500th cycle was defined as the in-plane pressure after durability test and in the case where the in-plane pressure was 32 kPa or higher, it was determined that the heat resistance was sufficient. The test results are shown in Table 1.

In this connection, the set gap at the time of starting the test, that is the gap set at the time of starting the test was a gap with which each holding material generated in-plane pressure of 150 kPa in the case where the compaction was carried out to narrow the gap between the sample stands at a speed of 25 mm/minute.

Test of Initial High Temperature in-Plane Pressure Test

The test was carried out at the following set gap at the time of starting the test in the same test method as that of the above-mentioned high temperature durability test and the maximum in-plane pressure value near the high temperature at the first cycle was defined as the initial high temperature in-plane pressure value. The test results are shown in Table 1.

In this connection, the set gap at the time of starting the test, that is the gap set at the time of starting the test was a gap with which each holding material generated in-plane pressure of 400 kPa in the case where the compaction was carried out to narrow the gap between the sample stands at a speed of 25 mm/minute. The in-plane pressure at the time of starting the test was defined as the canning in-plane pressure.

TABLE 1

| | | | | In-plane pressure | Canning in-plane |
|---|---|---|---|---|---|
| | Total | Ratio of | | after high | pressure-initial |
| | fiber | amount | | temperature | high temperature |
| | amount | of | V amount | durability test | in-plane pressure |
| Example | (g/m²) ^{a} | fibers ^{b} | (wt %) ^{c} | (kPa) | (kPa) |
| 1 | 1777 | 0.98 | 30 | 32.7 | — |
| 2 | 1783 | 1.19 | 30 | 34.7 | — |
| 3 | 1708 | 1.62 | 30 | 37.3 | — |
| 4 | 1457 | 1.98 | 30 | 33.9 | — |
| 5 | 1539 | 1.70 | 30 | 36.1 | — |
| 6 | 1728 | 1.57 | 23 | 32.6 | — |
| 7 | 1721 | 1.59 | 26 | 38.2 | — |
| 8 | 1715 | 1.60 | 28 | 40.2 | — |
| 9 | 1720 | 1.05 | 23 | — | −70 |
| 10 | 1695 | 1.08 | 30 | — | −21 |
| Comparative | 1369 | 1.80 | 30 | 28.6 | — |
| Example 1 | | | | | |
| Comparative | 1681 | 1.69 | 37 | 27.5 | — |
| Example 2 | | | | | |
| Comparative | 1662 | 1.13 | 37 | — | +43 |
| Example 3 | | | | | |
| Comparative | 1708 ^{d} | 1.62 | 30 | 24.9 | — |
| Example 4 | | | | | |

^{a} The amount of crystalline alumina fibers in the catalyst-carrier supporting material
^{b} The ratio of the crystalline alumina fibers in the heat resistant layer and the thermally intumescent layer
^{c} The amount of vermiculite in the heat resistant layer
^{d} The total fiber amount means the total of 1056 g/m² of crystalline alumina fibers in the heat resistant layer and 659 g/m² of ceramic fibers in the thermally intumescent layer.

### Fiber Amount Ratio

With respect to the fiber amount ratio defined as (fiber amount in heat resistant layer)/(fiber amount in thermally intumescent layer), those of Examples 1 to 4 were compared. It was confirmed that the in-plane pressure after the high temperature durability test exceeded 32 kPa, which means a sufficient heat resistance, in the case where the ratio of the fibers was in a range of 0.98 to 1.98.

### Total Fiber Amount

With respect to the total fiber amount, the total fiber amounts of Examples 3 and 6 were compared with the total fiber amount of Comparative Example 1. It was confirmed that the in-plane pressure after the high temperature durability test exceeded 32 kPa, which means a sufficient heat resistance, in the case where the total fiber amount was 1400 g/m² or higher.

### Vermiculite Content

With respect to the vermiculite content, the vermiculite contents of Examples 3 and 6 to 8 were compared with the vermiculite content of Comparative Example 2. It was confirmed that the in-plane pressure after the high temperature durability test exceeded 32 kPa, which means a sufficient heat resistance, in the case where the vermiculite content in the thermally intumescent layer was within a range of 23 to 33% by weight.

Further, in Examples 9 and 10 and Comparative Example 3, values of “canning in-plane pressures minus initial high temperature in-plane pressures” were compared. In the case where the initial high temperature in-plane pressure exceeds the canning in-plane pressure, it means that the pressure generated in the holding material at the high temperature in the first cycle exceeds the in-plane pressure set for the canning and because of the pressure difference, the catalyst-carrier may possibly damaged by pressure. In the case of Comparative Example 3, “the canning in-plane pressure minus the initial high pressure in-plane pressure” became positive, so that the vermiculite content is desirable to be 33% by weight or less.

### In the Case of Using Ceramic Fibers Inferior in the Heat Resistance for the Thermally Intumescent Layer

Based on the comparison between Example 3 and Comparative Example 4, it was confirmed that the in-plane pressure after the high temperature durability test exceeded 32 kPa, which means a sufficient heat resistance, in the case where crystalline alumina fibers were used for the thermally intumescent layer in Example 3, where it was confirmed that the thermally intumescent layer of ceramic fibers containing about 50% by weight of alumina in Comparative Example 4 did not have sufficient heat resistance.

What is claimed is:

1. A catalyst-carrier supporting material comprising:
a heat resistant layer which contains crystalline alumina fibers and an organic binder evenly impregnated with the crystalline alumina fibers and to be eliminated by thermal decomposition; and
a thermally intumescent layer layered on the heat resistant layer which contains crystalline alumina fibers, an organic binder dispersed in the crystalline alumina fibers and to be eliminated by thermal decomposition, and vermiculite dispersed in the crystalline alumina fibers, wherein
the crystalline alumina fibers exist in an amount of 1,400 g/m² or higher in the catalyst-carrier supporting material,
the ratio of the amount of the crystalline alumina fibers existing in the heat resistant layer and the amount of the crystalline alumina fibers existing in the thermally intumescent layer is 0.98 to 1.98, and
the vermiculite exists in an amount of 23 to 33% by weight in the thermally intumescent layer.

2. The catalyst-carrier supporting material according to claim 1, wherein the material is pressed in the thickness direction to have a thickness of 7 to 25 mm.

3. A catalytic converter comprising a cylindrical catalyst-carrier for an exhaust gas purification catalyst, a casing which houses the carrier and is connected to an exhaust gas introduction pipe, and a catalyst-carrier supporting material which is rolled around the carrier and fills the gap between the carrier and the casing, wherein
the catalyst-carrier supporting material is the catalyst-carrier supporting material according to claim 1 or 2 and disposed in a manner that the heat resistant layer faces to the carrier side.
